(19) United States
(12) Patent Application Publication
(10) Pub. No.: US 2009/0018896 A1
(43) Pub. Date: Jan. 15, 2009

(54) Scaled Subscriber Profile Groups for Emarketers

(75) Inventor: Christopher John McGreal, San Diego, CA (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 12/172,028

(22) Filed: Jul. 11, 2008

Related U.S. Application Data
(60) Provisional application No. 60/949,774, filed on Jul. 13, 2007.

(51) Int. Cl. G06Q 30/00

(52) U.S. Cl. 705/10

(57) ABSTRACT

A web based system and method for determining relevance of marketing group association by calculating the relevance factors of depth and weight of interest in a subscriber group is described. An emarketing management system typically includes a subscriber database, email marketing creation module, and a data management module. Collectively, the system allows marketers to group or segment subscribers according to marketing groups that are most relevant to the subscriber. By grouping or segmenting, marketers can design the most relevant content in subsequent email campaigns or distribution events, or to gain insight into subscriber behavior. The emarketing system may further integrate with external applications, such as a web analytic system or the emarketers own database, to gather, report and analyze data to refine relevance factors. A method for operating this system is also described.

This application claims the benefit of U.S. Provisional Application No. 60/949,774 filed 13 Jul. 2007, entitled “Weighted or Scaled Customer Profile Groups for eMarketers,” which is incorporated herein by reference.

### FIELD OF THE INVENTION

The present invention relates to commerce systems for use on the Internet. More particularly, the present invention relates to a system and method managing internet ad campaigns.

### BACKGROUND OF THE INVENTION

Some people think that the hardest part of getting an online business up and running is the planning and development of the website. However, the battle at that point is only half won. There is still the issue of getting people to visit the site, and more importantly getting those people to purchase something once they get there.

Thus, the main questions an online marketer must ask are: how does one get people to the site, how much does it cost, and what methods work best? Email marketing has become one of the most effective direct marketing strategies for generating results and ROI (return on investment). Among other things, online marketers use email to acquire new customers and to retain and communicate with (through transactional emails such as purchase and shipping notifications) current ones. When used in combination with web analytics, an eMarketing system can give the online marketer a tremendous amount of insight into who is visiting and buying the marketer's products.

In a February/March 2008 survey conducted by Forrester Research, 92% of online retailers surveyed stated that they used email marketing, and 93% said they planned to make it a higher priority this year. An average of 50% of address holders on these online retailer's lists have made at least one purchase from the retailers' web sites. According to the survey, email marketing is also one of the least expensive strategies in terms of cost per order (CPO), with an average CPO of $6.85 and an average dollar value of $120.27 per order. The only online marketing strategy with lower costs per order was “new portal deals,” with an average cost per order of $5.41 and an average order value of $42.50. The study compared these numbers to those for paid search delivered sales with an average $19.33 cost per order and an average dollar value of $109.17 per order, and for affiliate programs with an average cost per order of $12.24 and average order size of $122.51.

Email is an especially effective marketing tool. It delivers a message directly to one of the (potential) customer's primary communication channels and provides a link from the customer directly to the web site. It supports both on and off line channel sales and helps in building customer relationships. Each email sent out on a marketing campaign may be trackable and can provide an enormous amount of valuable, actionable data that can be used to further refine the marketer's targeting efforts and messages. The most effective email marketing solutions support database integration that allow the marketer to use the data it has collected to segment its subscribers into an almost unlimited number of groups, greatly improving the targeting and relevance of outgoing messages.

Among the data collected from customer email engagement, the marketer may find data supporting the factors that identify those most likely to repeat engagement with a marketing email message. History and experience have shown that past behavior and relevance of content are among the best customer-based indicators of repeat engagement. These factors, particularly relevance, become highly important for segmenting and targeting a marketing campaign.

A marketer may distribute an email newsletter with several links. If a customer interacts with a link, the eMarketing system generally puts the customer into the group related to that link. Additional interactions with other links result in the customer being placed in those groups as well. Over time, with more interaction, the data becomes less accurate because there may be no way of knowing which group assignment has more relevance for a specific subscriber. In other words, if a subscriber has clicked on 25 links that place them in a “men's shoes” group, and only 1 click that placed them in a “women's shoes” group the marketer has one user with two groups and no way to know which group is more relevant to the customer. For customers with a lot of groups, the distinction gets blurrier with each new group interaction.

The present invention provides a solution to these needs and other problems, and offers other advantages over the prior art.

### BRIEF SUMMARY OF THE INVENTION

The present invention is related to a software system that solves the above-mentioned problems.

In a preferred embodiment, this new method would allow marketers to not only record segments of customer interest via groups, it would allow them to see the “depth” or “weight” of interest a customer has in their respective groups. From a global perspective, it would also allow them to discover which groups have the deepest or shallowest level of interest from their overall subscriber/customer database. This information provides valuable insight into which customers should receive particular content that may increase the chances of conversion from a click to a sale.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates the context of scaled subscriber profiles over a network of subscribers.

FIG. 2 illustrates the process flow for generating and using relevance data in an email marketing system.

### DETAILED DESCRIPTION

### Common Terms Used

API post: a method of uploading subscriber data to an eMarketing database. Used in this invention to place subscribers in groups.

Fill group functionality: based on a click through interaction with an email a subscriber can be automatically added to a group; Fill group—customer clicks on a link and they are segmented into a group determined by the administrator prior to the launch to be related to the content of the link

Groups: a segment or interest area; a customer can manually opt into a group, be imported or placed in a group by an administrator, or auto filled into a group based on click thru interaction

Recency/frequency: date joined/last modified; dates and ranges.

SmartList™: A saved search or filter based on any combination of the subscriber data parameters.

Subscriber: a customer who has signed up for, or has not opted out of, receiving marketing emails from the marketer. For the purposes of this description, subscriber and customer are used interchangeably.

User: a customer, subscriber, or web visitor.

Web analytics: a system that collects data for users on a web site and provides reports on user behavior

### Overview

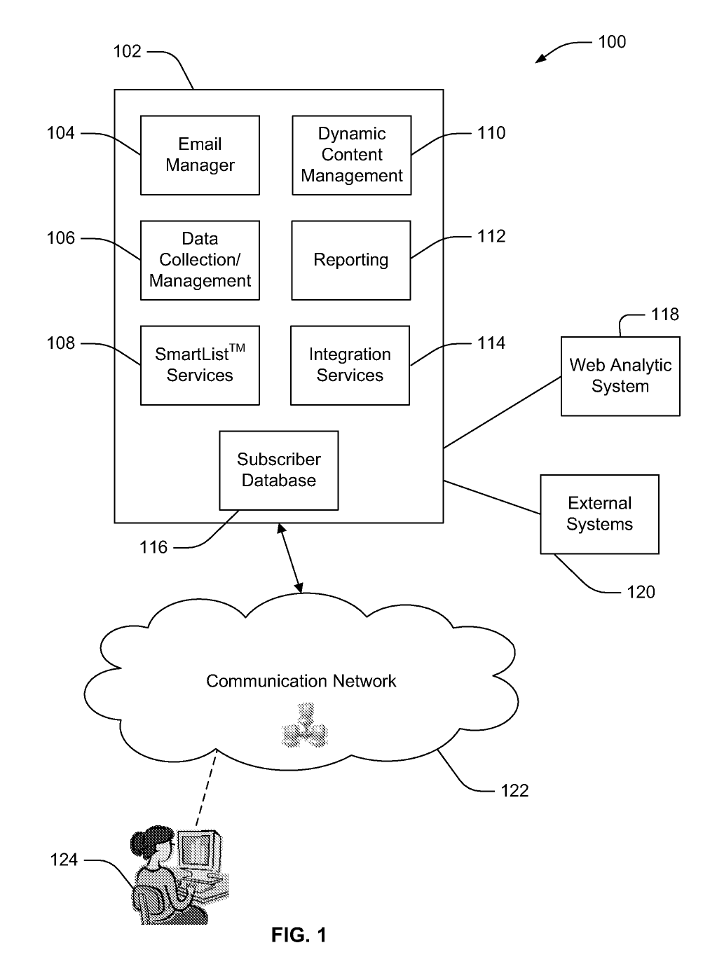

In a preferred embodiment, scaled subscriber profiles are created when subscribers indicate a preference for a segment or group through email engagement activities such as click thrus or survey responses, are assigned to a group by marketers based on their knowledge of the subscriber's behavior, or from online tracking of website behavior and purchase patterns by web analytic systems. Over time, those preferences may indicate the respective relevance to the subscriber of one group over another (but have to be scaled). FIG. 1 is a context diagram illustrating an exemplary system used in a preferred embodiment of scaled subscriber group profiling. As shown in FIG. 1, an email marketing system 102 contains several modules providing e-marketing services. Services that may be provided include email creation tools and campaign management 104, data collection and management 106, dynamic content templates and processes 110, SmartList™ querying and segmenting services 108, reporting 112 and external system integration 114. A subscriber database 116 holds all personal and demographic information provided by the subscriber, including email addresses for email distributions. Additional data and reporting can be provided by integrating with a web analytic system 118 or a marketer's own database or another system 120.

The email marketing system sends email messages over a network such as the internet 122, to the marketer's subscribers 124. Email messages, to be most effective, are personalized as much as possible to match the characteristics and preferences of the subscriber. The content provided typically contains links that are associated with the marketer's pre-defined marketing groups or segments. When the subscriber clicks thru the links, interest and behavioral data is collected 106 and recorded in the database 116. The next time the marketer runs a report 112 or initiates an email distribution event 104, the subscriber information is processed with a scaling factor, as described in detail below, to provide a highly accurate indication of the “depth” or “weight”—the relevance—of the the associated marketing group for each customer. This information is valuable in that it gives the marketer tremendous insight into its subscriber preferences, and also allows the most relevant content to be dynamically inserted into the email for a specific subscriber.

### Relevance

The new method described herein would allow marketers to not only record segments of customer interest via groups, it would allow them to see the “depth” or “weight” of interest a customer has in their respective groups. From a global perspective, it would also allow them to discover which groups have the deepest or shallowest level of interest from their overall subscriber/customer database. These factors describe the relevance of the group to the subscriber. Knowing what groups are most relevant to the subscriber allows the marketer to provide the most relevant message to the subscriber.

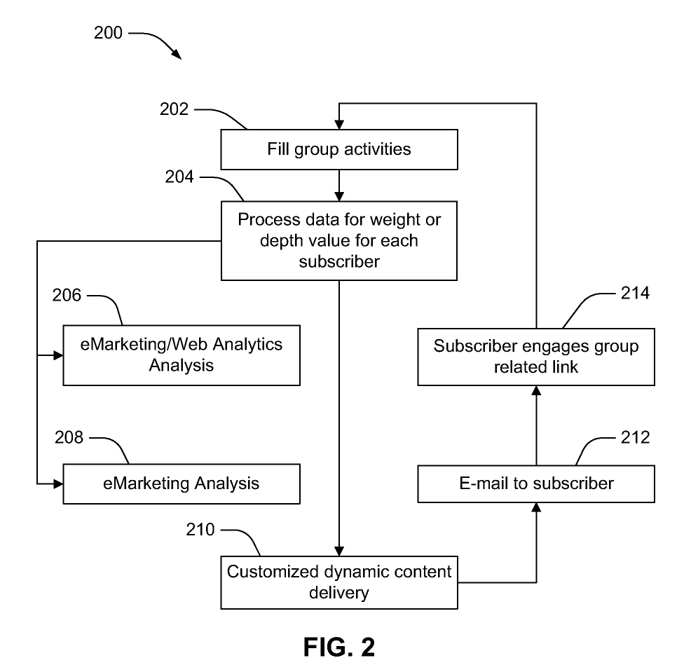

Referring to FIG. 2, in a preferred embodiment, an email marketing system would keep a record of how many times and when a subscriber is entered into (or engaged with) a group, as determined by email click-thrus, an API post, survey responses or manually entered data, relative to other categorically relevant groups 202. A process 204 would then be used to scale the relative weight or depth at which a subscriber exists in a group. Variables for the weighting process 204 may include:
the number of times a subscriber has triggered a rule to be entered into a weighted group (potentially measured in points);
the quantity of points a subscriber has for each group;
the total points a subscriber has accrued for all categorically relevant weighted groups;
the number of weighted groups the subscriber belongs to in a related set of groups;
a point value scale relative to recency of the engagement with the weighted group (i.e. the more recent the interaction the higher the point value of the interaction would be); and
the overall length of the customer relationship.

The score or value of a subscriber's engagement with any weighted group would not be a static value. It would be a value that would change over time 204 and with each interaction with that weighted group or any other weighted group in a related set. The marketer may supplement the system-collected data with survey or other data 202, the incorporation of which would require additional calculation 204. The values could be calculated on demand by the marketer or at a set interval and cached. The results may be used for reporting purposes; for example, to search for segments of subscribers 208. A marketer might query the system to return a list of customers who are in segment X with a certain degree of relevance (>50%). The data can be integrated with web analytics data for a richer set of reports that allow the marketer to further segment and analyze the behavior of the group members of interest 206. Additionally, this data may be used, with or without additional behavioral/segmentation data, as the business rules in a process that dynamically inserts content in an email 210, 212. As the customer engages the links in a subsequent email 214, new data is added 202 to the raw data used to calculate updated relevance factors.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments.

### Use Case

Using a preferred embodiment of the invention, a marketer segments its subscribers 202, into various groups in its marketing database. These groups are user-defined according to what is most appropriate for the marketer. The groups may be related to links in an email newsletter. For instance, a shoe company creates three groups that belong to a set or category called “Interest by Gender”:
men's shoes;
women's shoes; and
children's shoes.

Referring to Table 1, a single subscriber receiving six emails over the past six months may have the following behaviors 202:
Clicked six links for children's shoes between three and four months ago;
Clicked six links for men's shoes between four and six months ago; and
Clicked six links for women's shoes in the past three months.

The subscriber's interactions with each group may be recorded in the database (for instance, the number of times a link was clicked and a time stamp). A multiplier, as described in the first column of the table, may be used to indicate relative recency of visit 204. The data recorded in Table 1 shows that the subscriber interacted (based on clicks in email) with each group six times over the six month time period. If the method did not take into account the number of interactions, the marketer would have to assume their interest in all three groups was equal. However, by including the recency multiplier the marketer is empowered to determine that the subscriber is currently most interested in women's shoes (note the weighted score of 8.6), then children's shoes (weighted score of 7.4) and then men's shoes (weighted score of 6.5). The multiplier value may be a configured parameter in the system so a marketing administrator may set any value that is appropriate for his/her purposes.

TABLE 1

| | # of | | # of | | # of | | |
|---|---|---|---|---|---|---|---|
| | Interactions | | Interactions | | Interactions | | |
| | with | | with | | with | | |
| | Group 1 | Group 1 | Group 2 | Group 2 | Group 3 | Group 3 | |
| | (Men's | Weighted | (Women's | Weighted | (Children's | Weighted | Total |
| | Shoes) | Value | Shoes) | Value | Shoes) | Value | Interactions |
| 6 months ago | 2 | 2 | 0 | 0 | 0 | 0 | 2 |
| (multiplier = 1) | | | | | | | |
| 5 months ago | 2 | 2.1 | 0 | 0 | 0 | 0 | 2 |
| (multiplier = 1.1) | | | | | | | |
| 4 months ago | 2 | 2.4 | 0 | 0 | 4 | 4.8 | 6 |
| (multiplier = 1.2) | | | | | | | |
| 3 months ago | 0 | 0 | 1 | 1.3 | 2 | 2.6 | 3 |
| (multiplier = 1.3) | | | | | | | |
| 2 months ago | 0 | 0 | 2 | 2.8 | 0 | 0 | 2 |
| (multiplier = 1.4) | | | | | | | |
| Past month | 0 | 0 | 3 | 4.5 | 0 | 0 | 3 |
| (multiplier = 1.5) | | | | | | | |
| Totals | 6 | 6.5 | 6 | 8.6 | 6 | 7.4 | 18 |

The marketer may create a report 208 that allows him/her to see that the customer has not only clicked on each of the links within the category, but that the group most relevant to this particular customer is the women's shoes group. The data may also be used for further segmentation and analysis, for instance, determining which group has the highest concentration of heavily weighted subscribers. The data could be used in combination with existing segmentation methods such as part of a SmartList™ filter.

The marketer utilizing a web analytics system to analyze the behavior of its customers may integrate the two systems 206 to measure characteristics (e.g. orders by location) and observe behaviors (e.g. days or visits between a purchase) in each group or segment.

When running a subsequent marketing campaign, the eMarketing system 210 may use this data as the determining factor in deciding which of several promotions the customer will receive 212. For instance, the system may determine a segment of subscribers who meet a certain weight value criteria, and dynamically insert the most relevant content for the subscriber. The system may dynamically insert content containing a coupon for women's shoes for this subscriber, while another with a different relevance group would receive one for men's or children's shoes.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What is claimed is:

1. A web based subscriber profiling system for use on a network, comprising:
a subscriber profile database having subscriber behavior and email information; and
a software module operatively configured to record a segment of the subscriber profile database based on at least one of: (i) a depth interest and (ii) weight interest of a subscriber whereby a business can market goods or services to the subscriber.

2. The system of claim 1 wherein the software module is operatively configured to receive and process subscriber activity data to update segment data in the subscriber profile database such that links are associated with a particular segment.

3. The system of claim 2 wherein the software module is operatively coupled to a data source for the subscriber activity data selected from a group consisting of: a web analytics system, an email click-thru stream, an application programming interfact post, subscriber survey response system, and a manual data entry interface.

4. The system of claim 2 wherein the software module is operatively configured to scale the subscriber activity data while updating segment data in the subscriber profile database.

5. The system of claim 1 further comprising an email campaign manager operatively configured to send a personalized message to a subscriber over the network from a selected segment of the subscriber profile database whereby subscribers having similar depths or weights of interest are targeted for an email campaign.

6. The system of claim 5 wherein the email campaign manager generates the selected segment by utilizing scaled subscriber activity data to select particularly relevant subscriber information from the subscriber profile database.

7. The system of claim 1 wherein the subscriber profile database is operatively coupled to a web analytics system so that the analytic system may generate a report based on segment data from the subscriber profile database.

8. A method of email subscriber profiling, comprising steps of:
recording subscriber identifying information in a subscriber profile database; and
assigning a particular subscriber to a segment based on at least one of: (i) a depth interest and (ii) weight interest of a subscriber whereby a business can market goods or services to the subscriber.

9. The method of claim 8 further comprising a step of receiving subscriber activity data and wherein the assigning step comprises processing the subscriber activity data to update segment data in the subscriber profile database such that links are associated with a particular segment.

10. The method of claim 9 wherein the receiving step comprises operatively coupling to a data source for the subscriber activity data selected from a group consisting of: a web analytics system, an email click-thru stream, an application programming interface post, subscriber survey response system, and a manual data entry interface.

11. The method of claim 9 wherein the receiving step comprises receiving online survey data as the subscriber activity data and wherein a subscriber specifically identifies a relevance group.

12. The method of claim 9 wherein the receiving step comprises interfacing with and extracting data from a web analytic database for the subscriber activity data and wherein the extracted data includes one of: (i) opening email and (ii) click thru the email.

13. The method of claim 9 wherein the processing step comprises scaling the subscriber activity data while updating segment data in the subscriber profile database.

14. The method of claim 8 further comprising a step of sending a personalized message to a subscriber over the network from a selected segment of the subscriber profile database whereby subscribers having similar depths or weights of interest are targeted for an email campaign.

15. The method of claim 14 wherein the sending step comprises generating the selected segment by utilizing scaled subscriber activity data to select particularly relevant subscriber information from the subscriber profile database.

16. The method of claim 8 further comprising a step of generating a report based on segment data from the subscriber profile database.

17. The method of claim 8 further comprising steps of:
tracking subscriber email engagement; and
updating, based on the tracked subscriber email engagement, the subscriber profile database to refine the segment data related to one of: (i) the depth interest and (ii) the weight interest of a tracked subscriber.
